(19) United States
(12) Patent Application Publication
(10) Pub. No.: US 2007/0098023 A1
(43) Pub. Date: May 3, 2007

(54) Fiber laser and methods manufacture and use

(75) Inventors: Wei Lu, Centereach, NY (US); Zaza Sartania, Lake Grove, NY (US); Lin Xu, Nesconset, NY (US)

Correspondence Address: DARBY & DARBY P.C., P. O. BOX 5257, NEW YORK, NY, 10150-5257, US

(73) Assignee: Quantronix Corporation, East Setauket, NY (US)

(21) Appl. No.: 11/262,241

(22) Filed: Oct. 28, 2005

(51) Int. Cl. H01S 3/30; H01S 3/098

(52) U.S. Cl. 372/6; 372/18

(57) ABSTRACT

Fiber lasers include a fiber polarization controller to compensate for polarization variation In addition, fiber lasers include dual gain fibers to provide broader bandwidth for ultrashort pulse generation and amplification.

### FIELD

The invention is directed to fiber lasers and methods of manufacture and use of the fiber lasers. In addition, the invention is directed to fiber lasers using a fiber polarization controller to compensate for polarization variation, as well as fiber lasers with broader bandwidth for ultrashort pulse generation and amplification; and methods of manufacture and use of the fiber lasers.

### BACKGROUND

Fiber lasers can be used to produce relatively high power, ultrashort pulses. Some lasers are capable of providing subpicosecond pulses. There are many uses for such lasers including industrial and medical applications, such as telecomunnications, laser surgery, materials processing, and data transmission. A fiber laser is generally an optically-pumped resonator with a doped-fiber as a gain medium. Mode-locking is used to provide ultrashort pulses.

A soliton fiber ring laser was demonstrated in 1989 with an active modulator used for mode-locking. The early soliton fiber lasers suffered from environmental instability due to the onset of cavity noise. In an effort to generate stable, ultrashort pulses from a fiber laser, free space elements, such as prisms, waveplates, and faraday rotators, were added to the laser cavity to maintain the polarization. These components made the lasers relatively bulky and expensive. Other designs incorporated polarization-maintaining (PM) optical fiber. PM optical fiber is substantially more expensive than non-PM optical fiber.

### BRIEF SUMMARY

One embodiment is a fiber laser that includes a laser cavity having a first end and a second end. The laser cavity includes a first reflector disposed at the first end of the laser cavity; a second reflector disposed at the second end of the laser cavity to create with the first reflector a resonant oscillator within the laser cavity; a gain fiber disposed between the first and second reflectors and configured and arranged to amplify a beam of light; a fiber polarization controller configured and arranged to alter polarization of light in fiber and disposed between the first and second reflectors to modify the polarization of light oscillating within the laser cavity; and an in-fiber polarizer disposed to receive light from the fiber polarization controller and polarize the received light. The fiber laser also includes a pump light source to provide a pump beam for the gain fiber and an outlet for removing an output beam from the laser cavity.

Another embodiment is a fiber laser including a laser cavity comprising a gain fiber; a pump light source coupled to the laser cavity to provide a pump beam to the gain fiber; an outlet from the laser cavity to provide an output beam; and a frequency doubling unit to double the frequency of the output beam. The frequency doubling unit includes a frequency doubling material capable of doubling the frequency of the output beam at a temperature of no greater than 40° C.

Yet another embodiment is a fiber laser that includes a laser cavity having a first end and a second end. The laser cavity includes a first reflector disposed at the first end of the laser cavity; a second reflector disposed at the second end of the laser cavity to create with the first reflector a resonant oscillator within the laser cavity; a first gain fiber disposed between the first and second reflectors; and a second gain fiber disposed between the first gain fiber and the first reflector. The first and second gain fibers have overlapping gain bandwidths with different peaks. The fiber laser also includes at least one pump light source to provide a pump beam for the first and second gain fibers; and an outlet for removing an output beam from the laser cavity.

Another embodiment is a method for generating laser pulses. The method includes injecting a pump beam into a gain fiber disposed in a laser cavity to generate a laser beam within the cavity. The polarization of the laser beam in an optical fiber disposed in the cavity is modified using a polarization controller. The laser beam is directed through an in-fiber polarizer after the polarization of the laser beam is modified by the polarization controller. A portion of the laser beam is coupled out of the laser cavity to form an output beam.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic illustration of one embodiment of a fiber laser, according to the invention;

FIG. 2 is a schematic illustration of a second embodiment of a fiber laser incorporating a frequency doubling unit, according to the invention;

FIG. 3A is a graph illustrating gain profiles (C-band and L-band) for two gain fibers;

FIG. 3B is a graph of one combination of the two gain profiles of FIG. 3A;

FIG. 3C is a graph of the combination of two gain profiles of FIG. 3B when a long period grating is added to flatten the gain profile;

FIG. 4A is a schematic illustration of one embodiment of a dual gain fiber system, according to the invention;

FIG. 4B is a schematic illustration of another embodiment of a dual gain fiber system, according to the invention;

FIG. 5 is a schematic illustration of a third embodiment of a fiber laser incorporating double gain fiber systems, according to the invention;

FIG. 6A is a graph of the autocorrelation of 60 fs pulse (assuming hyperbolic secant) achieved using a fiber laser, according to the invention; and

FIG. 6B is a graph of a spectrum for a fiber laser, according to the invention.

### DETAILED DESCRIPTION

The invention is directed to fiber lasers and methods of manufacture and use of the fiber lasers. In addition, the invention is directed to fiber lasers using a fiber polarization controller to compensate for polarization variation, as well as fiber lasers with broader bandwidth for ultrashort pulse generation and amplification; and methods of manufacture and use of the fiber lasers.

Conventional fiber lasers that produce ultrafast pulses address the polarization evolution of the laser beam within the laser cavity. To maintain constant polarization a number of solutions have been proposed including the use of polarization-maintaining (PM) optical fiber and the inclusion of free space elements, such as prisms, waveplates, and faraday rotators, to compensate for polarization changes. PM optical fiber is substantially more expensive than ordinary optical fiber. Free space elements are bulky; need to be aligned properly for operation; and, in many cases, are also relatively expensive.

Furthermore, the duration of pulses generated from conventional fiber lasers and fiber amplifiers is limited by the gain bandwidth according to the Fourier principle. This limited gain bandwidth can adversely affect the stability of the fiber laser. For example, Er-doped gain fiber has substantially non-uniform gain with a bandwidth of approximately 40 nm, where bandwidth is measured as full width at half maximum.

A fiber laser can be made using fiber-based components to maintain the desired polarization without using PM optical fiber or free space elements such as prisms, waveplates, and faraday rotators. In particular, a fiber laser can include a laser cavity that receives a pump beam from a pump light source and which contains a gain fiber, a fiber polarization controller, and an in-fiber polarizer. The fiber polarization controller includes an optical fiber that is manipulated to alter the polarization of light through the optical fiber and the polarizer can clean up the polarization of the light received from the polarization controller. In one embodiment, stress birefringence is induced in the optical fiber by the fiber polarization controller to alter the polarization of light transmitted through the optical fiber. The laser cavity is preferably a linear cavity.

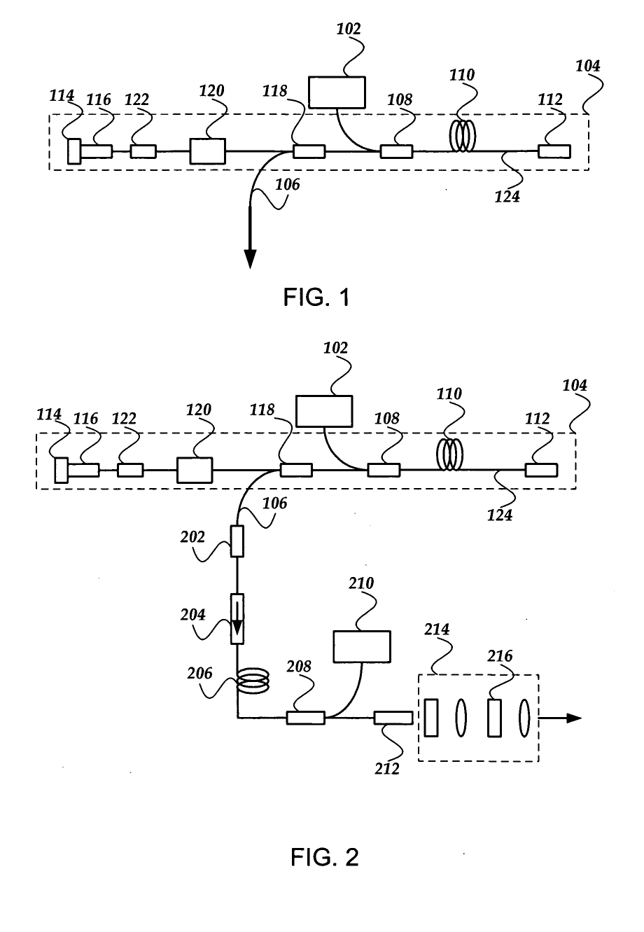

FIG. 1 illustrates one embodiment of a fiber laser 100 that does not need to use PM fiber or free space elements to maintain polarization of the light beam within the laser cavity 104. It will be understood that PM fiber may be used in the fiber laser 100, but it is not necessary. The fiber laser 100 includes a pump light source 102; a laser cavity 104 coupled to the pump light source; and a cavity outlet 106 to remove an output beam from the laser cavity. The laser cavity 104 includes a coupler 108 to couple the pump beam from the pump light source 102 into the laser cavity, a gain fiber 110, a first reflector 112, a second reflector 114, a mode-locking unit 116, an output coupler 118, a polarization controller 120, a polarizer 122, and one or more pieces of optical fiber 124.

The polarization controller and polarizer are both fiber-based components. Preferably, all of the components with the possible exception of the two reflectors 112, 114 and the mode-locking unit 116 are fiber-based components. More preferably, all of the components with the possible exception of the second reflector 114 and mode-locking unit 116 are fiber based components. Preferably, if one or more of the reflectors 112, 114 and the mode-locking unit 116 are not fiber based components, these components are attached directly to an end of fiber 124.

Although optical fiber 124 may be a single optical fiber stretching across the laser cavity 104, more typically the optical fiber 124 is made up of two or more pieces of optical fiber that are coupled together to form a continuous light path. Any method of coupling pieces of optical fiber can be used including, for example, fusion splicing. One or more of these pieces may be associated with particular components such as coupler 108, gain fiber 110, first reflector 112, output coupler 118, polarization controller 120, and polarizer 122. In this manner, the fiber from individual components can be coupled together to create the laser cavity 104.

The laser cavity 104 receives a pump beam from the pump light source 102 through the coupler 108. This pump beam is provided to the gain fiber 110; typically, an optical fiber with a doped fiber core. The gain fiber 110 can be pumped by the pump light source 102 to produce laser oscillations at a longer wavelength than the wavelength of the pump beam. The gain fiber uses the energy from the pump beam to amplify pulses of a laser beam in the laser cavity via stimulated emission. For example, the gain fiber can be a rare-earth doped optical fiber. Suitable rare-earth dopants include, for example, erbium, holmium, neodymium, samarium, thulium, ytterbium, and other rare earth elements. In some embodiments, combinations of dopants can be used to achieve a desired stimulated emission wavelength. Erbium doped fiber is one commonly used gain fiber. Such a gain fiber is sometimes referred to as an erbium-doped fiber amplifier (EDFA).

The frequency and amplification for a particular gain fiber can depend on a variety of factors including, for example, the specific doping ion(s) used in the fiber, the concentration of the doping ion(s), the pump light source frequency, the length of the gain fiber, etc. For example, an erbium-doped fiber can produce a lasing wavelength around 1560 nm. In one example, an erbium-doped fiber can be pumped using a 980 nm or 1480 nm semiconductor laser. The pump light source can have a pump power as high as 500 mW or more. One example of a suitable erbium doped fiber is relatively highly doped with a 30 dB/m peak absorption at 1530 nm.

For at least some embodiments, such as an Er-doped fiber laser with a center gain wavelength at 1560 nm, the gain fiber may have positive dispersion. Because the desired mode-locking operation (soliton mode-locking) generally requires negative dispersion, the positive dispersion of the gain fiber should be compensated. One manner of compensation is the use of a chirped fiber grating (see, e.g., K. Sugden, et al, Electron Lett., 30, 440 (1994), incorporated herein by reference.) The dispersion of the chirped fiber grating can be controlled, for example, by mechanical stress or thermal operation. The chirped fiber grating preferably has a reflectivity at the center wavelength, for example 1560 nm, of at least 80%, and, more preferably, at least 90%, 95%, 99%, or approximately 100%. The chirped fiber grating can be placed at one end of the cavity as a reflector. Another compensation scheme includes the use of an additional piece of standard optical fiber which has negative dispersion around 1560 nm. The amount of negative dispersion can be changed by adjusting the length of the standard single mode fiber. These compensation schemes, as well as any others known in the art, can be used alone or in combination.

The reflectors 112, 114 can be any suitable reflector capable of reflecting the laser light generated in the gain fiber 110. For example, one or both of the reflectors 112, 114 can be fiber mirror reflectors or fiber gratings (for example, chirped or non-chirped fiber gratings.) Alternatively or additionally, one or both of the reflectors can be mirrors that are coupled to the end of a fiber or to another component, such as the mode-locking unit 116. Such coupling can include, but is not necessarily limited to, physically attaching (e.g., adhesively or mechanically) the reflector to the fiber or other component.

Passive mode-locking can be realized by nonlinear polarization evolution. The polarization of the pulse is transformed by the in fiber polarization controller 120 into elliptical polarization. When passing through the fibers in the fiber laser cavity 104, the elliptical polarization is rotated. The angle of the rotation for light at each wavelength is proportional to the intensity of the light at that wavelength. Therefore, the light at the wavelength of peak intensity of the pulse experiences a substantially larger rotation than light at wavelengths where there is little intensity. The polarizer 122 can then be oriented to pass the polarization of light at the peak intensity. The off-peak wavelengths of light are then attenuated by the polarizer 122 because of the variation in polarization. Thus, the pulse becomes shorter and passive mode-locking is achieved. When the total cavity dispersion is negative, the pulse becomes a soliton.

Because this nonlinear polarization evolution is often not self-starting, a starting unit 116 can be used to assist in initiating mode-locking. It will be understood, however, that the starting unit 116 might not be used in systems where non-linear polarization evolution is self-starting. One suitable device for use in a starting unit 116 is a saturable absorber. The saturable absorber initiates passive mode-locking and suppresses continuum noise to stabilize a pulse (e.g., a soliton pulse) inside the laser cavity 104. In one embodiment, the saturable absorber is coupled to the optical fiber 124 of the laser cavity. The coupling can include, for example, physically attaching (e.g., adhesively or mechanically attaching) the saturable absorber to the fiber.

Any type of saturable absorber can be used. Examples of suitable saturable absorbers can be formed from chemical dyes, polymer, or semiconductor materials. For example, a suitable saturable absorber can have a bandgap that is less than the lasing wavelength so that the laser light in the laser cavity 104 can saturate the saturable absorber. Preferably, the saturable absorber changes from high loss to low loss as the absorber is saturated.

The polarization controller 120 modifies the polarization of the laser light as it travels along the fiber 124. One example of a suitable polarization controller is a device that is capable of inducing stress birefringence in the fiber. For example, the polarization controller may apply a force to at least partially bend, squeeze, stretch or otherwise induce asymmetric stress in the fiber. One example of a suitable polarization controller is the PolaRITE™ polarization controller from General Photonics Corp. (Chino, Calif.)

By inducing stress birefringence in the fiber, the index of refraction in fast and slow axes of the fiber become different. The identity of the fast and slow axes will depend on the stress placed on the fiber. This difference in index of refraction essentially creates a waveplate in the optical fiber that can rotate the polarization of light traveling through the fiber. By selecting the degree and direction of the stress, the desired polarization rotation can be achieved to maintain the polarization of the laser light in the fiber.

The laser cavity 104 also includes a polarizer 122. The polarizer 122 can clean-up the laser light by removing light having an unwanted polarization. Any type of in-fiber polarizer can be used including absorptive, transmissive, and reflective polarizers.

One example of a suitable in-fiber polarizer is a side-polished fiber that has a portion of the cladding removed and replaced with an overlay that preferentially reflects or waveguides one polarization of light. The other polarization may be substantially transmitted out of the fiber or absorbed by the overlay. Suitable materials for use in formation of a polarizing overlay include birefringent materials, metals, and oriented liquid crystals. In-fiber polarizers using other methods of polarization selection can also be used.

In at least some embodiments, the polarization controller 120 and the in-line polarizer 122 can provide Kerr-type polarization evolution that can shorten and clean the laser pulses (e.g., soliton laser pulses.) Furthermore, the polarization controller and polarizer can maintain the polarization of the laser beam and can thereby facilitate environmental stability of the laser cavity oscillator. Preferably, the laser is sufficiently environmentally stable so that the polarization controller need not be adjusted or is only adjusted on a periodic basis, for example, adjusted on a daily, monthly, or yearly basis to compensate for component drift. Such adjustments may be made manually or automatically.

The pump light source 102 provides pump light to the laser cavity via the coupler 108. The pump light source can be any suitable light source that can produce light to be absorbed by the gain fiber 110 resulting in the stimulated emission of laser light at the desired laser frequency. The pump light source can be, for example, a laser, (e.g., a semiconductor laser), a light-emitting diode, or a filtered broadband light source, such as an arc lamp. Preferably, the pump light source is a laser. For example, a 980 nm or 1480 nm pump light laser can be used with an erbium-doped gain fiber to produce laser light at around 1560 nm.

In at least some embodiments, a fraction of the pump beam is not absorbed by the gain fiber 110. In some of these embodiments, the fiber laser may include a mechanism for reducing the power of the remnant of the pump beam after it has traversed the gain fiber to improve operation. For example, the reflector 112 may transmit or absorb at least a portion of the pump beam or a bandpass filter may be added to absorb light from the pump beam and transmit the laser beam generated by the gain fiber.

The coupler 108 can be any suitable device for coupling the light from pump light source into the fiber. One example of a suitable coupler is a wavelength division multiplexer (WDM). In one embodiment, the WDM is configured for coupling energy between two different channels near 1560 nm and 980 nm (or 1480 nm.) The WDM can be positioned on either side of the gain fiber.

The output coupler couples a portion of the light out of the laser cavity to be used for a desired application. The output coupler can have any coupling ratio of output light to light remaining in the cavity. For example, the coupling ratio can be in the range from 10/90 to 50/50.

Accordingly, in one embodiment the laser cavity 104 can be formed using substantially all-fiber components except the saturable absorber, and associated reflector which are attached to one end of the laser cavity. Moreover, the polarization of the laser light can be maintained using the described in-fiber components and without requiring PM optical fiber. This arrangement can be less expensive and/or more compact than conventional fiber lasers, if desired.

FIG. 2 illustrates a fiber laser 200 that includes the same components as fiber laser 100. The fiber laser 200 also includes a polarization controller 202, an isolator 204, a second gain fiber 206, a pump coupler 208, a second pump light source 210, a collimator 212, and a frequency doubling unit 214 including a frequency doubling material 216. This arrangement can be used, for example, to convert a 1560 nm laser cavity into a 780 nm output. The components of the fiber laser 200 with the same reference numerals as the components in fiber laser 100 are the same or substantially similar to the corresponding components described above.

In operation, laser light is coupled out of the laser cavity 114, as described above, to form an output beam. This output beam can be amplified using the gain fiber 206 and second pump light source 210. The isolator 204 prevents the amplified output beam from returning to the laser cavity 104. The polarization controller 202 is used to maintain the polarization of the output beam by at least partially (preferably, fully) offsetting any polarization change. The amplified laser light is provided to the collimator 212 which directs the light to the optics of the frequency doubling unit 214 and the frequency doubling material 216. In some embodiments, the output beam of the laser cavity 104 can be provided to the frequency doubling unit 214 without further amplification. The polarization controller 202 may also be optional, particularly if the polarization of the output beam is otherwise sufficiently maintained.

The gain fiber 206, second pump light source 210, and pump coupler 208 are components whose description and design considerations can be the same as, or similar to, the components described above as gain fiber 110, pump light source 102, and coupler 108. In a particular fiber laser, these respective components can be the same or different from each other. For example, in at least some instances the second gain fiber 206 can have higher doping than the gain fiber 110 and can, therefore, be shorter while providing the same, or a larger, degree of amplification, if desired. The second gain fiber 206 is also preferably a high birefringence fiber. Such an arrangement can provide an amplifier which is substantially linear and useful for broadband signal amplification.

The polarization controller 202 can be a component similar to that described above with respect to polarization controller 120. The isolator 204 is disposed between the laser cavity and the second gain fiber to prevent feedback of a portion of the output beam into the laser cavity and can be any conventional isolating component.

The frequency doubling unit 214 can contain one or more optical elements, such as lenses, mirrors, polarizers, wave-plates, and the like. Objectives of these optical elements can include directing the laser light from the collimator 212 onto the frequency doubling material 214 and providing output light from the frequency doubling unit with a desired set of optical parameters.

Any frequency doubling material can be used. One commonly used material is periodically poled lithium niobate (PPLN) crystal. Generally, a PPLN crystal is operated at 100° C. or greater to prevent or reduce photorefractive damage. The damage threshold of PPLN is about 10 kW/cm².

Preferably, however, a frequency doubling material is used that does not need elevated temperature to perform frequency doubling over a substantial period of time. Preferably, the frequency doubling material will provide satisfactory frequency doubling at room temperature or at a temperature of 40° C. or less and, more preferably, at a temperature of 30° C. or less. Examples of suitable frequency doubling materials that have this characteristic are periodically poles near-stoichiometric lithium tantalate (PP-SLT) and periodically poled magnesium doped lithium niobate (PP-MgO:LN). The poling periodicity, as well as the width of the material, can be selected to achieve the desired optical effect.

The damage threshold of PP-SLT or PP-MgO:LN is more than 1,500 kW/cm², much higher than the damage threshold of PPLN. Therefore, these crystal can be made very thin and still avoid the damage from strong focusing of the lens. The spectral acceptance of a crystal is inversely proportional to the thickness of the crystal. As a result, the acceptance bandwidth of a thin crystal can be comparable or even broader than the fundamental signal bandwidth. Thus, PP-SLT or PP-MgO:LN can be more suitable for the frequency conversion of a broadband fundamental seed signal.

As one example, a seed signal from the laser cavity 104 is about 2.8 mW with center wavelength of 1560 nm. The spectral bandwidth is about 9 nm. The repetition rate of the pulse train is about 32 MHz. The length of gain fiber 110 is about 1 m. The gain fibers 110 and 206 have an Er-doping level with peak absorption of 30 dB/m and 55 dB/m at 1530 nm, respectively. The length of gain fiber 206 is about 0.8 m. With 200 mW pump power, an average power of 40 mW with S-polarization was obtained from the amplifier. After the frequency doubling unit, the center wavelength is about 780 nm, as illustrated in FIG. 6B. The pulse width after frequency doubling is about 60 fs as shown in FIG. 6A. The pulse is stable with output power of 8.5 mW.

In another embodiment, one or both of the gain fibers 110, 206 (and associated pump light sources 102, 210 and couplers 108, 208) is replaced by a dual gain fiber system that can be used to provide broadband amplification, if desired. The dual gain fiber system includes two gain fibers. Preferably, these two gain fibers have different gain peaks where one is blue-shifted and the other is red-shifted from a desired central wavelength. When the outputs of these two gain fibers are combined, the overall gain can have a broader gain linewidth. The final gain profile can be controlled by, for example, adjusting the pump level of the two gain fibers, the relative length of the gain fibers, or a combination thereof.

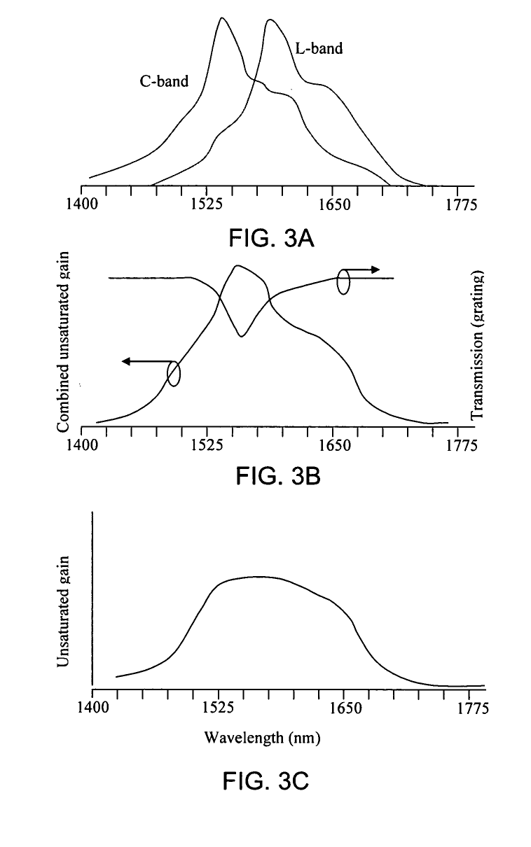

An example of the combination of the output of two gain fibers is illustrated in FIGS. 3A-3C. FIG. 3A illustrates the gain profiles for two Er-doped fibers with gain in the C-band (3 dB gain from 1525 to 1565 nm) and L-band (3 dB gain from 1560 to 1600 nm), respectively. FIG. 3B illustrates the combined gain profile for the combination of these C-band or L-band gain fibers.

In at least some instances, as illustrated in FIG. 3B, the gain profile is non-uniform or asymmetric. A long-period fiber grating (LPG) or other component can be used to adjust the gain. The long period grating couples the guided mode to a forward-propagating cladding mode to induce the desired loss at the appropriate wavelength within the gain spectrum. By doing this, the total gain profile is substantially flattened, which effectively broadens the gain linewidth, as shown in the FIG. 3C. It will be recognized that other notch filtering components can be used in place of the long period grating.

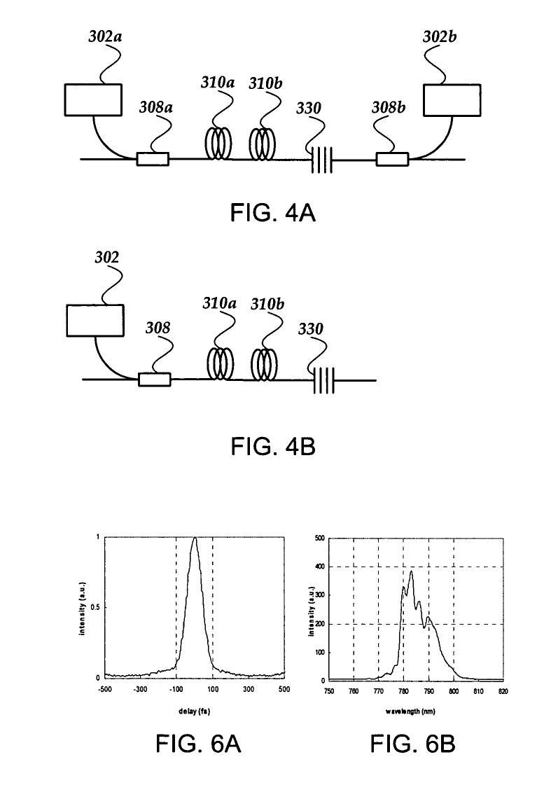

FIGS. 4A and 4B illustrate two variations of a dual gain fiber system with two gain fibers 310a, 310b. The system of FIG. 4A includes two pump light sources 302a, 302b and two couplers 308a, 308b disposed on opposite sides of the two gain fibers 310a, 310b, as well as a long period grating 330 disposed on either side of the gain fibers. The pump level of the two pump sources 302a, 302b can be adjusted to control the combined gain profile. Preferably, the length of the two gain fibers is fixed.

The system of FIG. 4B includes a single pump light source 302 and a coupler 308 disposed on either side of the two gain fibers 310a, 310b and a long period grating 330 disposed on the either side of the gain fibers. The length and order of the gain fibers relative to the single pump light source can be selected or adjusted to control the gain profile.

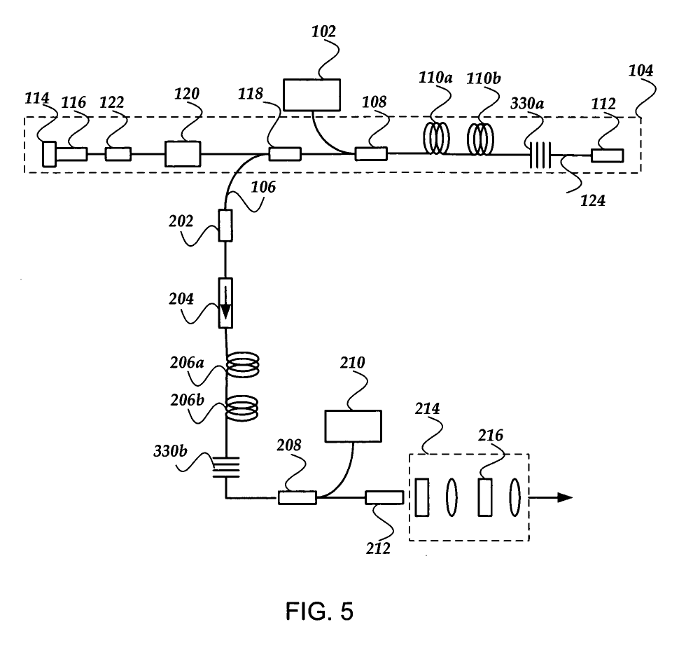

The dual gain fiber systems of FIGS. 4A and 4B can be substituted into the fiber lasers of FIGS. 1 and 2 for one or, preferably, both of a) the gain fiber 110, pump light source 102, and coupler 108 and (for FIG. 2) b) the gain fiber 206, pump light source 210, and coupler 208. FIG. 5 illustrates one embodiment of a fiber laser with two gain fibers 110a, 110b in the laser cavity 104 and two gain fibers 206a, 206b in the amplifier section, as well as long period gratings 330a, 330b (which may be the same or different.) It will also be understood that the dual gain fiber system can be used in other fiber laser configurations including those without an in-fiber polarization controller or in-fiber polarizer.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A fiber laser, comprising:
a laser cavity having a first end and a second end, the laser cavity comprising
a first reflector disposed at the first end of the laser cavity,
a second reflector disposed at the second end of the laser cavity to create with the first reflector a resonant oscillator within the laser cavity,
a gain fiber disposed between the first and second reflectors and configured and arranged to amplify a beam of light,
a fiber polarization controller configured and arranged to alter polarization of light in fiber and disposed between the first and second reflectors to modify the polarization of light oscillating within the laser cavity, and
an in-fiber polarizer disposed to receive light from the fiber polarization controller and polarize the received light;
a pump light source to provide a pump beam for the gain fiber; and
an outlet for removing an output beam from the laser cavity.

2. The fiber laser of claim 1, further comprising a mode-locking unit disposed in the cavity to sharpen pulses of light.

3. The fiber laser of claim 1, wherein the fiber polarization controller comprises an optical fiber and a stress inducer, wherein the fiber polarization controller is configured and arranged to produce stress birefringence in the optical fiber to alter polarization of light traveling through the fiber.

4. The fiber laser of claim 1, further comprising a saturable absorber disposed between the two reflectors.

5. The fiber laser of claim 1, wherein the outlet comprises a second fiber polarization controller to modify the polarization of the output beam in an optical fiber.

6. The fiber laser of claim 1, wherein the outlet comprises a second gain fiber to amplify the output beam.

7. The fiber laser of claim 6, wherein the outlet comprises a second pump light source to provide a pump beam to the second gain fiber.

8. The fiber laser of claim 1, wherein the outlet comprises a frequency doubling material disposed to receive the output beam and double a frequency of the output beam.

9. The fiber laser of claim 8, wherein the frequency doubling material is configured and arranged to double the frequency of the output beam at a temperature of no more then 40° C.

10. The fiber laser of claim 8, wherein the frequency doubling material comprises periodically poled magnesium doped lithium niobate or periodically poled magnesium doped stoichiometric lithium tantalate.

11. The fiber laser of claim 1, wherein the laser cavity is linear.

12. The fiber laser of claim 1, wherein the laser cavity does not contain polarization-maintaining optical fiber.

13. The fiber laser of claim 1, wherein the first reflector is a grating.

14. A fiber laser, comprising:
a laser cavity comprising a gain fiber;
a pump light source coupled to the laser cavity to provide a pump beam to the gain fiber;
an outlet from the laser cavity to provide an output beam; and
a frequency doubling unit to double the frequency of the output beam, the frequency doubling unit comprising a frequency doubling material capable of doubling the frequency of the output beam at a temperature of no greater than 40° C.

15. The fiber laser of claim 14, wherein the frequency doubling material is selected from periodically poled magnesium doped lithium niobate and periodically poled magnesium doped stoichiometric lithium tantalate.

16. The fiber laser of claim 14, wherein an acceptance bandwidth of the frequency doubling material is at least as broad as a bandwidth of a beam received by the frequency doubling unit.

17. A method for generating laser pulses, the method comprising:
injecting a pump beam into a gain fiber disposed in a laser cavity to generate a laser beam within the cavity;
modifying the polarization of the laser beam in an optical fiber disposed in the cavity using a polarization controller;
directing the laser beam through an in-fiber polarizer after the polarization of the laser beam is modified by the polarization controller; and
coupling a portion of the laser beam out of the laser cavity to form an output beam.

18. The method of claim 17, further comprising sharpening pulses of the laser beam using a saturable absorber.

19. The method of claim 17, further comprising modifying the polarization of the output beam in an optical fiber using a polarization controller.

20. The method of claim 17, further comprising doubling a frequency of the output beam using a frequency doubling material at a temperature of no more than 40° C.

21. The method of claim 17, further comprising doubling a frequency of the output beam using a frequency doubling material selected from periodically poled magnesium doped lithium niobate and periodically poled magnesium doped stoichiometric lithium tantalate.

22. The method of claim 17, further comprising amplifying the output beam using a second gain fiber and a second pump beam.

23. A fiber laser, comprising:
a laser cavity having a first end and a second end, the laser cavity comprising
a first reflector disposed at the first end of the laser cavity,
a second reflector disposed at the second end of the laser cavity to create with the first reflector a resonant oscillator within the laser cavity,
a first gain fiber disposed between the first and second reflectors, and
a second gain fiber disposed between the first gain fiber and the first reflector, wherein the first and second gain fibers have overlapping gain bandwidths with different peaks;
at least one pump light source to provide a pump beam for the first and second gain fibers; and
an outlet for removing an output beam from the laser cavity.

24. The fiber laser of claim 23, wherein the fiber laser comprises only one pump light source to pump the first and second gain fibers.

25. The fiber laser of claim 23, wherein the fiber laser comprises two pump light sources coupled into the laser cavity on opposite sides of the first and second gain fibers.

26. The fiber laser of claim 23, further comprising a long period grating disposed in the laser cavity to receive output from the first and second gain fibers.

27. The fiber laser of claim 23, wherein the outlet comprises a pair of second gain fibers to amplify the output beam.

28. The fiber laser of claim 23, further comprising a fiber polarization controller configured and arranged to alter polarization of light in fiber and disposed between the first and second reflectors to modify the polarization of light oscillating within the laser cavity, and an in-fiber polarizer disposed to receive light from the fiber polarization controller and polarize the received light.
